(19) United States
(12) Patent Application Publication
(10) Pub. No.: US 2026/0368568 A1
(43) Pub. Date: Nov. 19, 2026

(54) INFORMATION PROCESSING APPARATUS

(71) Applicant: NEC Corporation, Tokyo (JP)

(72) Inventor: Yoshitaka NOZAKI, Tokyo (JP)

(73) Assignee: NEC Corporation, Tokyo (JP)

(21) Appl. No.: 19/657,534

(22) Filed: Apr. 24, 2026

(30) Foreign Application Priority Data
May 13, 2025 (JP) 2025-080518

(51) Int. Cl. G06N 5/045

(52) U.S. Cl. CPC G06N 5/045

(57) ABSTRACT

An information processing apparatus of the present disclosure includes a prediction unit that predicts an objective variable representing a state of a prediction target by inputting, to a prediction model, vector data obtained by vectorizing explanatory variables, each of the explanatory variables being data related to the prediction target, a calculation unit that calculates, as an explainability index, a contribution of each element of the vector data to the objective variable, and an output unit that edits, for each of the explanatory variables, the explainability index for each element of the vector data corresponding to the explanatory variable to a predetermined number, and outputs information based on an editing result.

### INCORPORATION OF BASIC APPLICATION

The present invention is based upon and claims the benefit of the priority of Japanese Patent Application No. 2025-080518 filed on May 13, 2025 in Japan, the disclosure of which is incorporated herein in its entirety by reference.

### Technical Field

The present disclosure relates to an information processing apparatus.

### Background Art

PTL 1 (JP 2023-154167 A) describes that a health condition of a patient is predicted from a data set including an attribute of the patient, examination data, and the like by using a machine learning model. PTL 1 (JP 2023-154167 A) describes that feature values are extracted from the data set and degrees of influence of the individual feature values on the predicted health condition are calculated.

### SUMMARY

However, in the technology of PTL 1 (JP 2023-154167 A) described above, in a case where the feature values are represented in a high dimension for the data set, there arises a problem that explainability of the degrees of influence of the feature values on prediction decreases.

It is therefore an object of the present disclosure to solve the above-described problem that explainability for prediction using a machine learning model decreases.

One aspect of the present disclosure provides an information processing apparatus including:
a prediction unit that predicts an objective variable representing a state of a prediction target by inputting, to a prediction model, vector data obtained by vectorizing explanatory variables, each of the explanatory variables being data related to the prediction target;
a calculation unit that calculates, as an explainability index, a contribution of each element of the vector data to the objective variable; and
an output unit that edits, for each of the explanatory variables, the explainability index for each element of the vector data corresponding to the explanatory variable to a predetermined number, and outputs information based on an editing result.

One aspect of the present disclosure provides an information processing method including,
by an information processing apparatus:
   predicting an objective variable representing a state of a prediction target by inputting, to a prediction model, vector data obtained by vectorizing explanatory variables, each of the explanatory variables being data related to the prediction target;
   calculating, as an explainability index, a contribution of each element of the vector data to the objective variable; and
   editing, for each of the explanatory variables, the explainability index for each element of the vector data corresponding to the explanatory variable to a predetermined number, and outputting information based on an editing result.

One aspect of the present disclosure provides a program for causing an information processing apparatus to execute processing including:
predicting an objective variable representing a state of a prediction target by inputting, to a prediction model, vector data obtained by vectorizing explanatory variables, each of the explanatory variables being data related to the prediction target;
calculating, as an explainability index, a contribution of each element of the vector data to the objective variable; and
editing, for each of the explanatory variables, the explainability index for each element of the vector data corresponding to the explanatory variable to a predetermined number, and outputting information based on an editing result.

With the above configuration, the present disclosure can improve explainability for prediction using a machine learning model.

### BRIEF DESCRIPTION OF THE DRAWINGS

FIG. 1 is a block diagram illustrating an example of a configuration of an information processing apparatus according to the present disclosure;

FIG. 2 is a flowchart illustrating an example of a processing operation by the information processing apparatus according to the present disclosure;

FIG. 3 is a diagram illustrating an example of processing by the information processing apparatus according to the present disclosure;

FIG. 4 is a diagram illustrating an example of processing by the information processing apparatus according to the present disclosure;

FIG. 5 is a diagram illustrating an example of processing by the information processing apparatus according to the present disclosure;

FIG. 6 is a diagram illustrating an example of processing by the information processing apparatus according to the present disclosure;

FIG. 7 is a diagram illustrating an example of processing by the information processing apparatus according to the present disclosure;

FIG. 8 is a diagram illustrating an example of processing by the information processing apparatus according to the present disclosure;

FIG. 9 is a block diagram illustrating an example of a hardware configuration of the information processing apparatus according to the present disclosure;

FIG. 10 is a block diagram illustrating an example of a configuration of the information processing apparatus according to the present disclosure; and

FIG. 11 is a flowchart illustrating an example of a processing operation by the information processing apparatus according to the present disclosure.

### EXAMPLE EMBODIMENT

### First Example Embodiment

A first example embodiment of the present disclosure will be described with reference to the drawings. The drawings may relate to any example embodiment.

As an example, an information processing apparatus 10 of the present disclosure is used to predict a state of a patient from an explanatory variable, which is data related to the patient, by using a machine learning model, and present a contribution of the explanatory variable to the prediction to a medical worker such as a doctor or the patient. As a result, it is possible to improve explainability by presenting the contribution of the explanatory variable to the prediction, and it is also possible to support decision making by the doctor or the like.

In the present disclosure, a prediction target is not limited to a patient. For example, the information processing apparatus 10 according to the present disclosure may be used to set a computer system as a prediction target, predict a state such as abnormality of the computer system from an explanatory variable, which is data related to the computer system, and present the contribution of the explanatory variable. In the present disclosure, the prediction target may be anything, and the state to be predicted may be any state of the prediction target.

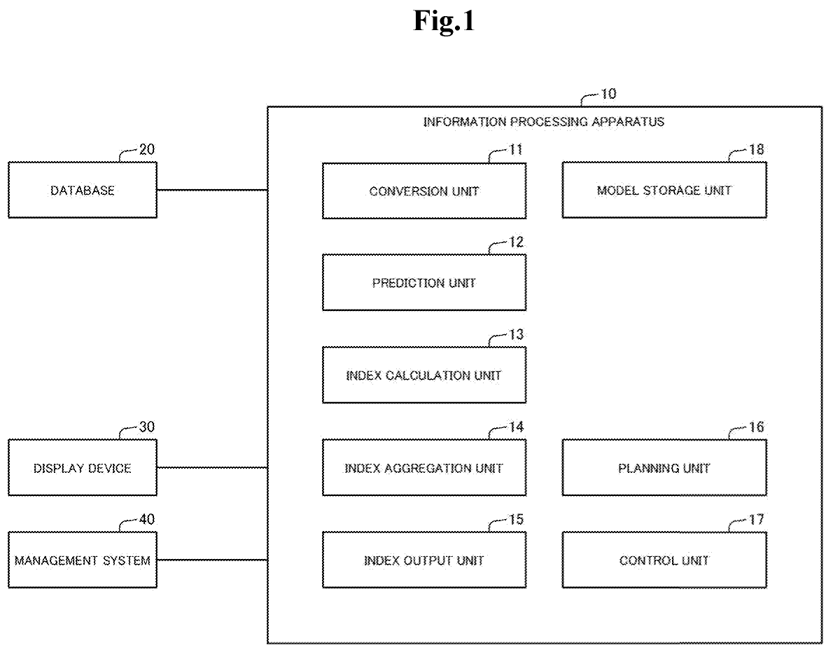

Hereinafter, an example of a configuration and an operation of the information processing apparatus 10 according to the present example embodiment will be described. The information processing apparatus 10 is configured with one or a plurality of information processing apparatuses including arithmetic devices and storage devices. Then, as illustrated in FIG. 1, the information processing apparatus 10 includes a conversion unit 11, a prediction unit 12, an index calculation unit 13, an index aggregation unit 14, an index output unit 15, a planning unit 16, and a control unit 17. Each function of the conversion unit 11, the prediction unit 12, the index calculation unit 13, the index aggregation unit 14, the index output unit 15, the planning unit 16, and the control unit 17 can be achieved by the arithmetic device executing a program for achieving each function stored in the storage device. The information processing apparatus 10 also includes a model storage unit 18 achieved by the storage device. The information processing apparatus 10 is connected with a database 20, a display device 30, and a management system 40.

The database 20 stores patient data, which is data related to patients set as prediction targets. In the present example embodiment, the patient data includes, as explanatory variables that are feature values of the patient, attributes of the patient (for example, age and gender), time-series data of biometric data measured from the patient (for example, heart rate, temperature, and percentage of red blood cells), text data indicating the state of a patient P (for example, an electronic medical record), and image data obtained by capturing an image of the patient (for example, a computed tomography (CT) image). As described above, the patient data includes explanatory variables in different data formats, such as text, numerical values, and images. However, the patient data is not limited to the above-described types of data, and may include any type of data.

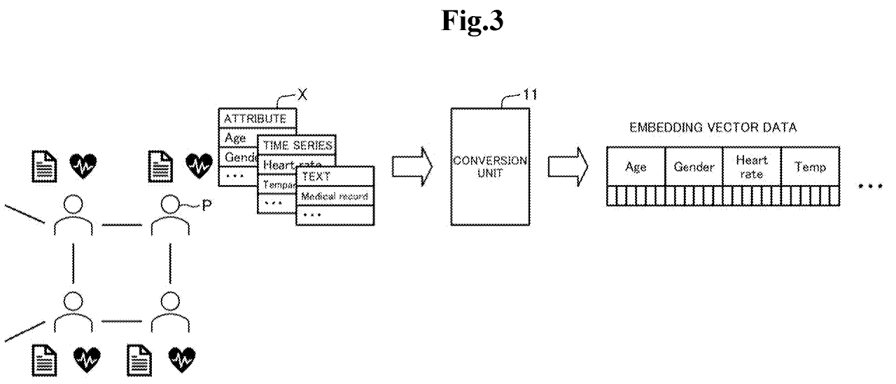

The conversion unit 11 (acquisition unit) acquires the patient data of the patients set as the prediction targets from the database 20 described above. Then, the conversion unit 11 constructs graph data in which the patients are connected to each other in such a way as to represent relevance between the patients. For example, as illustrated in FIG. 3, the conversion unit 11 constructs graph data called a property graph in which the patients P are regarded as nodes, each node includes explanatory variables X, which are feature values of the patient P, and the patients P, that is, the nodes, are connected to each other. At this time, as an example, the conversion unit 11 constructs the property graph by connecting nodes between the patients P having mutual relevance from commonality in the patient data of the patients P or the like. However, the conversion unit 11 may construct the property graph by any method. The patient data from which the property graph has been constructed may be registered in the database 20 in advance, and the conversion unit 11 may acquire the patient data in the form of the property graph from the database 20.

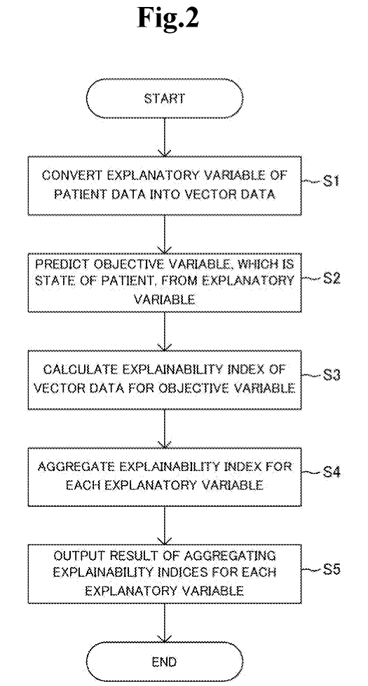

Subsequently, the conversion unit 11 converts each explanatory variable X of the patient data into vector data vectorized into a predetermined number of elements (step S1 in FIG. 2). At this time, based on the state of connection between the patients P, that is, between the nodes, and content of each explanatory variable X in the patient data, the conversion unit 11 converts each explanatory variable X into vector data including multidimensional elements. As an example, the conversion unit 11 converts each one of the explanatory variables X into vector data including 64-dimensional elements. However, the conversion unit 11 may convert the explanatory variable X into vector data of any number of dimensions.

Here, the conversion unit 11 converts each explanatory variable X of the patient data into vector data by using a conversion model stored in advance in the model storage unit 18. In the present example embodiment, it is assumed that the conversion model is an embedding propagation (EP) model generated by machine learning in such a way as to convert graph data into embedding vector data by an EP technique. Specifically, the EP model learns an embedded representation of each explanatory variable in consideration of the relevance between the nodes by unsupervised learning of learning data, which has been prepared in advance, of a property graph in which the nodes are connected to each other as described above. This allows the conversion unit 11 to obtain embedding vector data having multidimensional elements for each explanatory variable in consideration of the connection between the patients P by inputting the patient data of the patients P to the EP model as illustrated in FIG. 3.

The conversion unit 11 may convert each explanatory variable X of the patient data into vector data by using a conversion model other than the EP model described above. At this time, the conversion unit 11 is not always required to construct a property graph, in which the patients P are connected to each other, from the patient data, and may vectorize each explanatory variable from the patient data of each patient P. In this case, it is assumed that the conversion model is machine-learned by, for example, an autoencoder in such a way as to extract the feature value of each explanatory variable as vector data. This allows the conversion unit 11 to obtain embedding vector data having multidimensional elements for each explanatory variable by inputting the patient data of the patients P to the conversion model.

However, the conversion unit 11 is not necessarily limited to converting each explanatory variable X of the patient data into vector data by using the conversion model as described above, and may generate the vector data by any technique. For example, the conversion unit 11 may extract a feature value in accordance with the content of each explanatory variable X by performing predetermined arithmetic processing on each explanatory variable X of the patient data, and generate vector data based on the feature value. In a case where each explanatory variable X of the patient data of the patient P has been converted into vector data in advance by an external device or the like, the conversion unit 11 may acquire, from the external device, the vector data in a state where each explanatory variable X of the patient data has been converted.

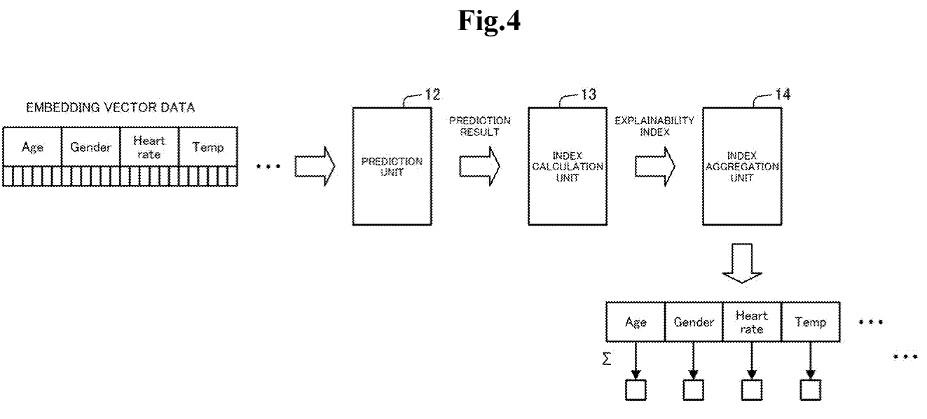

The prediction unit 12 predicts an objective variable, which is the state of the patient P (outcome), from the embedding vector data obtained by converting each explanatory variable X of the patient P (step S2 in FIG. 2). Specifically, the prediction unit 12 predicts the objective variable, which is the state of the patient P, from the embedding vector data of the patient P by using a prediction model stored in advance in the model storage unit 18. At this time, examples of the objective variable, which is the state of the patient P to be predicted, include a hospitalization period (the number of days) of the patient P, the number of days alive (days) of the patient P, and death in hospital (0: alive, 1: in-hospital death). The prediction model is generated by machine learning of embedding vector data obtained by converting the patient data of the patient P as described above prepared in advance as learning data and ground truth data, which is the state of the patient P (outcome) (for example, the hospitalization period or in-hospital death). Thus, the prediction unit 12 can obtain a prediction result, which is the state of the patient P (outcome), by inputting the embedding vector data of the patient P to the prediction model as illustrated in FIG. 4. Examples of the prediction model include a prediction model based on Extreme Gradient Boosting (XGBoost).

The prediction unit 12 is not limited to using the above-described XGBoost model as the prediction model, and may predict the state of the patient P by using another decision tree-based model or a linear model. The prediction unit 12 is not necessarily limited to predicting the state of the patient P by using the prediction model as described above, and may predict the state of the patient P by any technique. For example, the prediction unit 12 may predict the state of the patient P by performing predetermined arithmetic processing on the embedding vector data.

The index calculation unit 13 (calculation unit) calculates, as an explainability index, the contribution of each element of the embedding vector data to the objective variable, which is the state of the patient P predicted as described above (step S3 in FIG. 2). Specifically, the index calculation unit 13 calculates a SHapley Additive exPlanations (SHAP) value, which is an index quantitatively indicating the contribution of each piece of the embedding vector data, that is, each feature value, to the prediction. As a result, the index calculation unit 13 can calculate the explainability index indicating how much each element (feature value) of the embedding vector data has positively or negatively affected the prediction result.

The index calculation unit 13 is not necessarily limited to calculating the explainability index for each element of the vector data by using the SHAP value described above, and may calculate the explainability index by any technique. For example, in a case where the prediction model used in the prediction unit 12 described above is a linear model, the index calculation unit 13 may use a coefficient of the linear model as the explainability index.

The index aggregation unit 14 (output unit) edits the explainability index for each element of the embedding vector data calculated as described above for each explanatory variable X of the patient data (step S4 in FIG. 2). In the present example embodiment, for one explanatory variable X, the index aggregation unit 14 aggregates the explainability indices individually corresponding to a plurality of elements corresponding to the explanatory variable X into one. For example, as illustrated in FIG. 4, the index aggregation unit 14 obtains a sum of the explainability indices corresponding to the elements of the embedding vector data including the number of dimensions such as 64 dimensions for each explanatory variable X (e.g., age or gender), and aggregates the sum into an explainability index including one dimension. As a result, one one-dimensional explainability index is calculated for each explanatory variable X (e.g., age or gender).

The sum of the explainability indices is calculated and aggregated into one explainability index for each explanatory variable X in the above description, but it is also possible to aggregate the explainability indices into a one-dimensional explainability index by performing another type of aggregation processing. For example, the index aggregation unit 14 may take maximum values of the explainability indices and aggregate the maximum values into one explainability index for each explanatory variable X, or may calculate weighted average values and aggregate the weighted average values into one explainability index. The index aggregation unit 14 is not necessarily limited to performing aggregation to obtain one explainability index for each explanatory variable X, and may perform editing to obtain a predetermined number of explainability indices. At this time, the index aggregation unit 14 may perform editing for each explanatory variable X in such a way that the number of explainability indices is dimensionally reduced as compared with the number of dimensions of the embedding vector data.

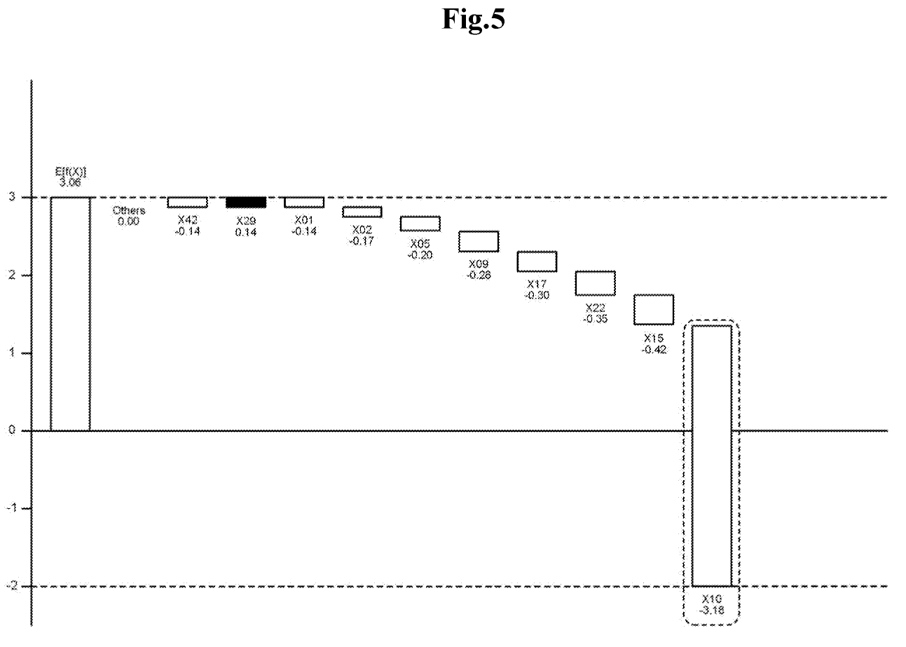

The index output unit 15 (output unit) outputs information based on the explainability index aggregated for each explanatory variable X as described above in such a way as to be displayed on the display device 30 (step S5 in FIG. 2). As an example, the index output unit 15 presents the explainability index for each explanatory variable X by a waterfall plot. The waterfall plot starts from an expected value E of the prediction model, adds or subtracts influence (contribution) of each explanatory variable X on the prediction result in ascending order of influence, and presents a final prediction value as a goal. Here, FIG. 5 illustrates an example in which the explainability index for each explanatory variable X is presented by a waterfall plot. In this drawing, “XAA” represents the AA-th explanatory variable X, the numerical value under “XAA” represents the contribution, and a bar graph having a length (magnitude) in accordance with the numerical value of the contribution is presented. At this time, the index output unit 15 presents the bar graph in the form of a black bar graph extending upward in a case where the sum is positive, or in the form of a white bar graph extending downward in a case where the sum is negative. Then, in the example in FIG. 5, as surrounded by a dotted line, it can be seen that the contribution of the explanatory variable “X10” is the largest.

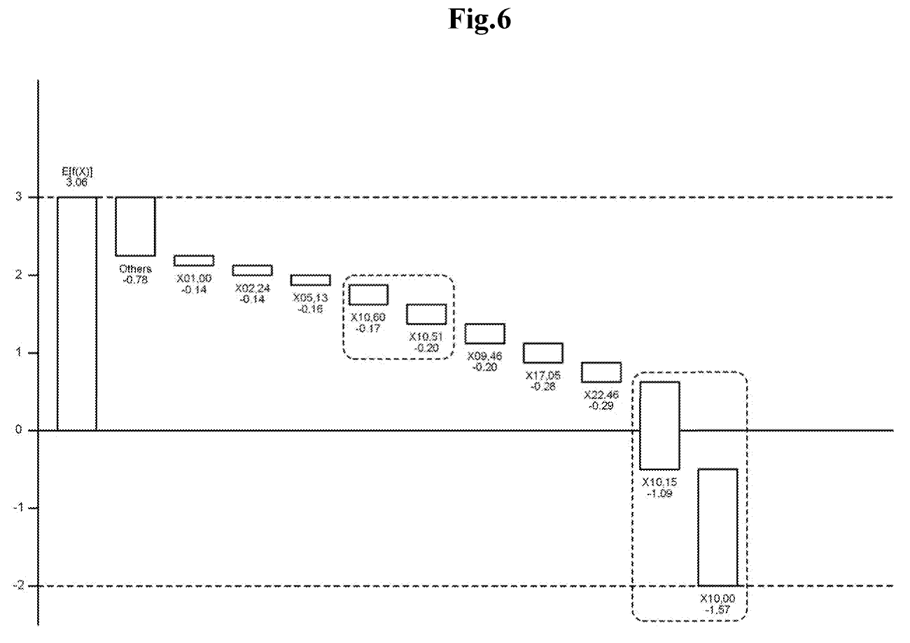

Here, FIG. 6 illustrates a case where the contribution of each element of the embedding vector data is presented by a waterfall plot, without aggregating the explainability indices of each explanatory variable X. In this drawing, “XAA, BB” indicates a BB-th embedding vector element in the AA-th explanatory variable X, and the numerical value under “XAA, BB” represents the contribution. Then, in the example in FIG. 6, as surrounded by dotted lines, the contributions of the embedding vector elements of the explanatory variable “X10” are represented by different graphs. This makes it difficult to recognize which explanatory variable X contributes to what extent, and there is a problem that the explainability on an explanatory variable X-by-explanatory variable X basis decreases.

On the other hand, in the present example embodiment, the contribution is presented by one graph (bar graph) for each explanatory variable as illustrated in FIG. 5, and this makes it easier to recognize the contribution for each explanatory variable. As a result, it is possible to improve the explainability (interpretability) on an explanatory variable X-by-explanatory variable X basis for the prediction.

Attempting to directly calculate, hold, or display the contribution of each element for a high-dimensional embedding vector causes the number of display elements to explode as compared with the number of explanatory variables to be explained, and increases the amount of memory required to hold a contribution calculation result, the amount of calculation required for rearrangement, aggregation, or graph generation of the contributions, the number of drawing instructions to the display device, and the amount of data transmitted to a display terminal via a network. This may result in a delay in real-time display and an increase in processing load, and cause a decrease in processing performance of the information processing apparatus as well as a decrease in explainability. On the other hand, in the present example embodiment, the contributions of the individual elements of the embedding vector corresponding to the explanatory variable are aggregated, so that the number of dimensions of contribution information is reduced, and calculation resources required for holding, transferring, and drawing the contribution information are reduced. This makes it possible to reduce a processing delay related to presentation of an explanation result, and present the prediction result and explanation information within a practical time frame even under a limited calculation resource (CPU/GPU/memory) environment or network environment.

While the above description shows a case where the explainability index aggregated for each explanatory variable X is presented by a waterfall plot, the explainability index may be presented in any form. For example, with 0 as an axis, the explainability index aggregated for each explanatory variable X may be illustrated in descending order in a bar graph. It is also possible to preferentially display the explainability index of an important explanatory variable X preset for each disease, or to aggregate the explanatory variables X for each preset category and display the explainability index.

The planning unit 16 (output unit) generates and outputs treatment plan information of the patient P based on the explainability index aggregated for each explanatory variable X. For example, in a case where the prediction result by the prediction unit 12 described above is “death in hospital (1: in-hospital death)” and the contribution of the explanatory variable X “X10” is the largest as illustrated in FIG. 5, the planning unit 16 generates a treatment plan for improving a measurement value (for example, the percentage of red blood cells) of the patient P corresponding to the explanatory variable X “X10” in such a way as to prevent a situation of the prediction result. At this time, the planning unit 16 may generate a treatment plan by using a model obtained by performing machine learning in advance regarding a relationship between a prediction result and an explanatory variable having a high contribution, and a treatment plan for such a situation. Alternatively, the planning unit 16 may acquire a treatment plan generated by a large language model by inputting a prediction result and an explanatory variable having a high contribution to the large language model and making a request to generate a treatment plan for such a situation. Then, the planning unit 16 presents the generated treatment plan to a medical worker such as a doctor to allow the doctor or the like to refer to the presented treatment plan and support decision making by the doctor or the like.

The planning unit 16 is not limited to generating a treatment plan, and may generate any information regarding a measure that can be applied to the patient P. For example, in a case where the prediction result by the prediction unit 12 described above is the “hospitalization period (the number of days)”, and the contribution of the explanatory variable X “X10” is the largest and has a positive influence on the prediction, the planning unit 16 may generate an action plan for discharge of the patient P.

The control unit 17 (output unit) controls a predetermined device based on the explainability index aggregated for each explanatory variable X. Here, the device is assumed to be, for example, the management system 40 for bed management in a hospital. At this time, it is assumed that the prediction result by the prediction unit 12 described above is the “hospitalization period (the number of days)”, and the contribution of the explanatory variable X “X10” is the largest as illustrated in FIG. 5, and in this case, it can be determined that the prediction has a high accuracy. Then, the control unit 17 assumes that the hospital bed will become vacant in accordance with the hospitalization period (the number of days) of the patient P, and controls hospital bed vacancies managed by the management system 40.

The control unit 17 is not limited to controlling the management system 40 for bed management, and may control any target such as another system or device in the hospital. For example, in conjunction with the treatment plan generated based on the explainability index by the planning unit 16 described above, the control unit 17 may generate information for making a reservation of a medical device required for the patient P and a reservation of a laboratory or an operating room, and perform control so that reservation processing is executed by the management system 40 for making these reservations.

The control unit 17 may give a control command to the management system 40 only in a case where the prediction has an accuracy equal to or more than a predetermined value based on the explainability index edited for each explanatory variable. As a result, it is possible to reduce erroneous control by using a result of editing the explainability index and to improve control quality with which the information processing apparatus controls an external device.

Here, in a case where the prediction target is a computer system, the planning unit 16 and the control unit 17 described above can function as follows. For example, the planning unit 16 may generate and output operation plan information of the computer system based on the explainability index aggregated for each explanatory variable X. As an example, the operation plan information of the computer system that controls the value of the explanatory variable X having the largest contribution may be generated. Then, the control unit 17 may control the computer system based on the operation plan information described above. Alternatively, the control unit 17 may control another device that may affect the operation of the computer system based on the explainability index aggregated for each explanatory variable X. As an example, in a case where the explanatory variable X having the largest contribution is a value related to the environment where the computer system is installed, a device such as an air conditioner that controls such a value may be controlled.

As described above, in the present disclosure, the explainability index is aggregated and presented for each explanatory variable, and this makes it easier to recognize the contribution of each explanatory variable to prediction, and makes it possible to improve the explainability (interpretability). In addition, it is also possible to take an appropriate measure in accordance with the contribution of the explanatory variable.

### Second Example Embodiment

Next, a second example embodiment of the present disclosure will be described with reference to the drawings. The drawings may relate to any example embodiment.

An information processing apparatus 10 according to the present example embodiment has a configuration similar to that of the first example embodiment. In addition, the information processing apparatus 10 has the following configuration. Hereinafter, a configuration different from the above will be mainly described.

An index aggregation unit 14 of the information processing apparatus 10 according to the present example embodiment aggregates an explainability index for each element of embedding vector data by dividing the explainability indices into positive contributions and negative contributions for each explanatory variable X. Specifically, the index aggregation unit 14 calculates a sum of positive values and a sum of negative values of the explainability index for each explanatory variable X. That is, for a certain explanatory variable X, the index aggregation unit 14 calculates a first index by the sum of just positive values in a case where the explainability indices include positive values, calculates a second index by the sum of just negative values in a case where the explainability indices include negative values, and holds the first index and the second index.

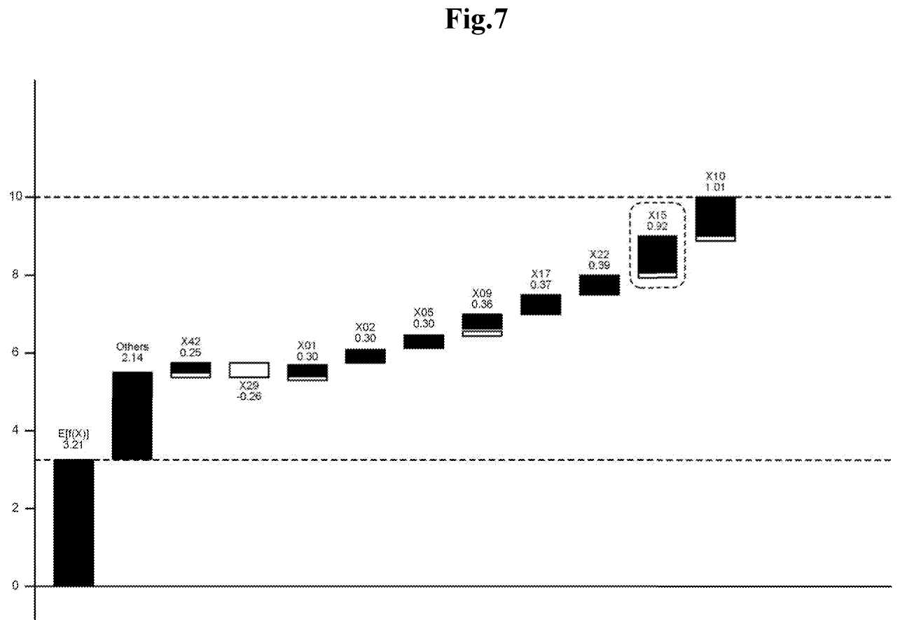

Then, an index output unit 15 of the information processing apparatus 10 according to the present example embodiment outputs information based on the first index and the second index aggregated for each explanatory variable X to be displayed on the display device 30. As an example, as illustrated in FIG. 7, the index output unit 15 displays, on the same axis for each explanatory variable X, a bar graph having a length in accordance with the value of the first index, which is the sum of the positive contributions, in such a way as to extend in a positive direction (upward), and a bar graph having a length in accordance with the value of the second index, which is the sum of the negative contributions, in such a way as to extend in a negative direction (downward). For example, the graphs surrounded by a dotted line in FIG. 7 correspond to the explanatory variable X “X15”, in which the white bar graph extending downward represents the negative contributions, and the black bar graph extending upward represents the positive contributions.

As described above, in the present example embodiment, the explainability indices are aggregated into two dimensions, positive and negative, for each explanatory variable X, and the explainability indices aggregated into two dimensions are displayed in such a way as to be distinguished from each other. As a result, it is possible to recognize the positive contributions and the negative contributions of the explanatory variables X, and it is possible to further improve explainability on an explanatory variable X-by-explanatory variable X basis. For example, even in a case where the explanatory variables X are complex data such as image data or time-series data, a medical worker such as a doctor can carefully observe the data corresponding to these explanatory variables X by recognizing the positive contributions and the negative contributions.

In the example in FIG. 7, the bar graphs corresponding to the positive and negative explainability indices are displayed in directions opposite to each other on the same axis, but the explainability indices may be displayed by any method. For example, with 0 as a reference, bar graphs corresponding to the positive and negative explainability indices may be displayed in directions opposite to each other and distinguished from each other by color or display form, or bar graphs corresponding to the positive and negative contributions may be displayed in the same direction and distinguished from each other by color or display form. In the above description, the explainability indices are aggregated into two dimensions, positive and negative, for each explanatory variable X, but may be aggregated in dimensions equal to or more than three dimensions. For example, the index aggregation unit 14 may set equal to or more than three sections as ranges of the values of the explainability indices, and perform aggregation by taking the sum of the explainability indices for each section. As a result, it is possible to aggregate the explainability indices multidimensionally for each explanatory variable X, and by presenting the aggregated information, it is possible to improve explainability in accordance with the section.

### Third Example Embodiment

Next, a third example embodiment of the present disclosure will be described with reference to the drawings. The drawings may relate to any example embodiment.

An information processing apparatus 10 according to the present example embodiment has a configuration similar to that of the first and second example embodiments. In addition, the information processing apparatus 10 has the following configuration. Hereinafter, a configuration different from the above will be mainly described.

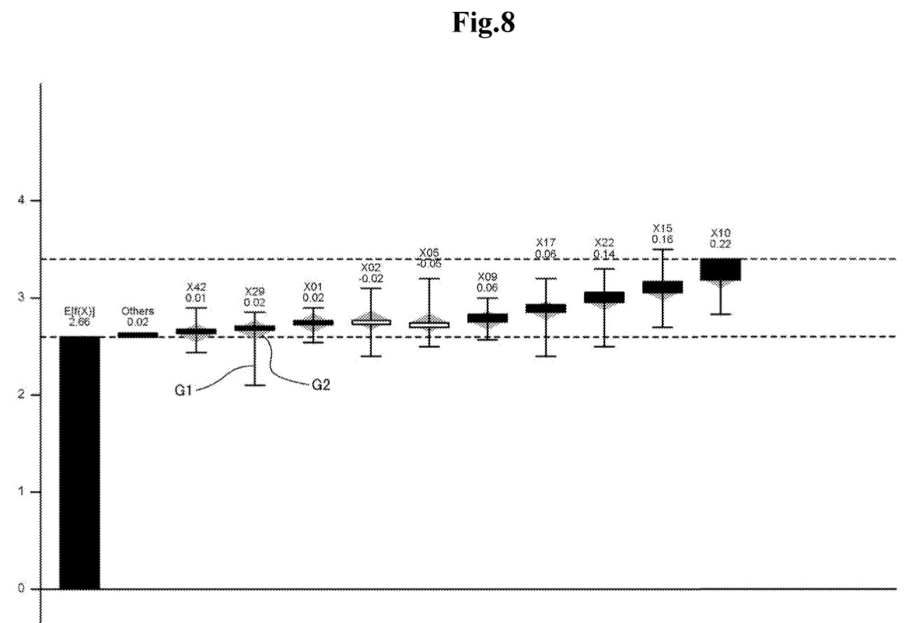

As in the first example embodiment, an index output unit 15 of the information processing apparatus 10 according to the present example embodiment outputs a bar graph (second graph) in accordance with a value of an explainability index obtained by aggregating a sum for each explanatory variable X. At this time, as illustrated in FIG. 8, the index output unit 15 illustrates a black bar graph in a case where the sum is positive, and illustrates a white bar graph in a case where the sum is negative.

In addition, the index output unit 15 according to the present example embodiment also outputs and displays distribution information (first graph) of the corresponding explainability index for each explanatory variable. For example, the index output unit 15 displays, as the distribution information, a range graph G1 representing a possible range of the explainability index corresponding to the explanatory variable X. The range graph G1 includes horizontal lines individually corresponding to a maximum value and a minimum value, and a vertical line indicating the possible range obtained by connecting the maximum value and the minimum value. For example, the index output unit 15 displays, as the distribution information, a violin plot G2 representing a probability density distribution of the explanatory variable X.

As described above, in the present example embodiment, the distribution of the explainability indices is also displayed together with the value obtained by aggregating the explainability indices for each explanatory variable X, and this makes it possible to compare a patient P with all other patients, and also makes it easier to recognize characteristics unique to the patient P.

In FIG. 8, as described in the second example embodiment, a graph of binarized values such as the sum of the positive explainability indices and the sum of the negative explainability indices may be displayed, or a graph corresponding to another aggregated value may be displayed.

### Fourth Example Embodiment

Next, a fourth example embodiment of the present disclosure will be described with reference to the drawings. In the present example embodiment, an outline of the information processing apparatuses and the like described in the above-described example embodiments will be illustrated. The drawings may relate to any example embodiment.

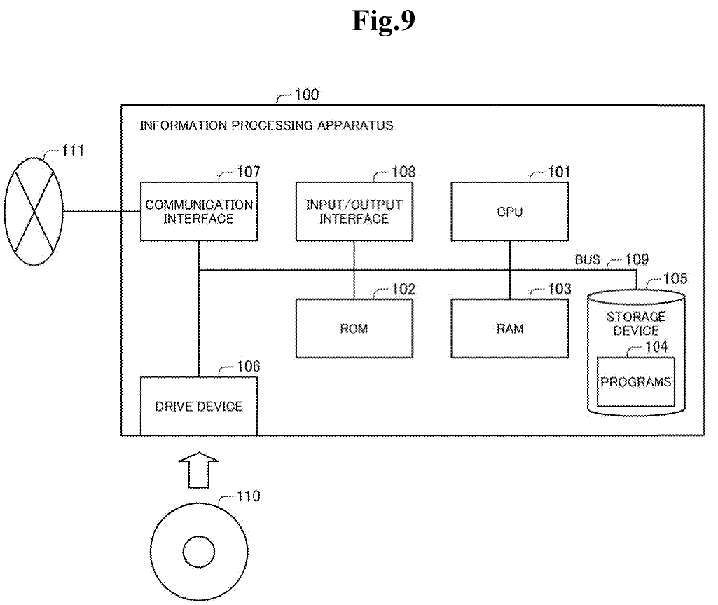

First, a hardware configuration of an information processing apparatus 100 in the present disclosure will be described. The information processing apparatus 100 is constituted by a general information processing apparatus and has the following hardware configuration, as illustrated in FIG. 9, as an example.

A central processing unit (CPU) 101 (arithmetic device)

A read only memory (ROM) 102 (storage device)

A random access memory (RAM) 103 (storage device)

Programs 104 to be loaded into the RAM 103

A storage device 105 that stores the programs 104

A drive device 106 that performs reading and writing on a storage medium 110 outside the information processing apparatus

A communication interface 107 connected to a communication network 111 outside the information processing apparatus

An input/output interface 108 that inputs and outputs data

A bus 109 that connects each component

FIG. 9 illustrates an example of the hardware configuration of the information processing apparatus that is the information processing apparatus 100, and the hardware configuration of the information processing apparatus is not limited to the above case. For example, the information processing apparatus may be constituted by a part of the above configuration such as not including the drive device 106. The information processing apparatus can use, instead of the above-described CPU, a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

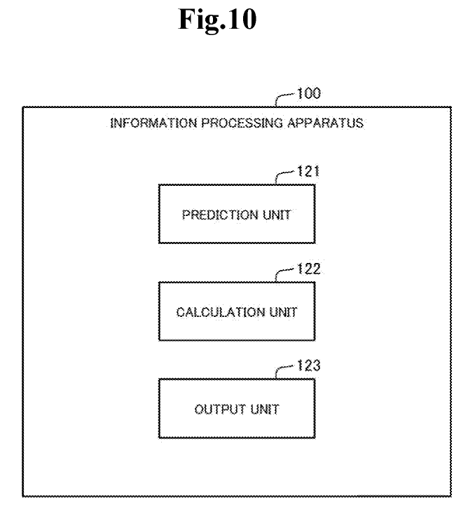

Then, the CPU 101 acquires and executes the programs 104 in such a way that the information processing apparatus 100 can construct and be equipped with a prediction unit 121, a calculation unit 122, and an output unit 123 illustrated in FIG. 10. The programs 104 are stored in, for example, the storage device 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive device 106 may read the programs 104 and supply the read programs 104 to the CPU 101. However, the prediction unit 121, the calculation unit 122, and the output unit 123 described above may be constructed by a dedicated electronic circuit for achieving the means.

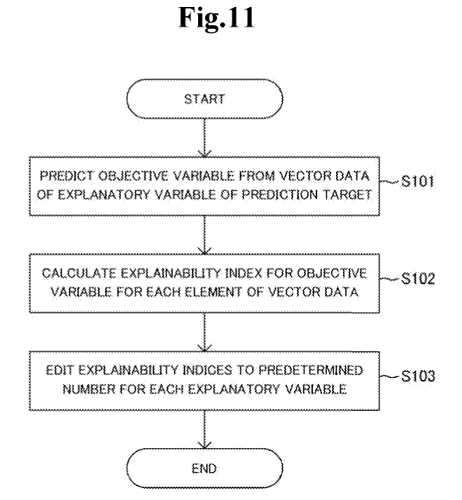

The prediction unit 121 inputs vector data obtained by vectorizing each explanatory variable, which is data related to a prediction target, to a prediction model to predict an objective variable representing the state of the prediction target (step S101 in FIG. 11). For example, the prediction unit 121 inputs vector data in which each explanatory variable is vectorized into elements of a predetermined number of dimensions to the prediction model to predict the state of the prediction target.

The calculation unit 122 calculates, as an explainability index, a contribution of each element of the vector data to the objective variable (step S102 in FIG. 11). For each explanatory variable, the output unit 123 edits the explainability index for each element of the vector data corresponding to the explanatory variable to a predetermined number, and outputs information based on an editing result (step S103 in FIG. 11). For example, the output unit 123 edits, for each explanatory variable, the explainability index in such a way as to be dimensionally reduced as compared with the number of dimensions of the vector data, and outputs information based on the editing result. As an example, for each explanatory variable, the output unit 123 obtains a one-dimensional value, which is the sum of the explainability indices, or obtains two-dimensional values, which are the sum of positive values and the sum of negative values of the explainability indices.

In the above configuration, the information processing apparatus 100 aggregates and presents the explainability index for each explanatory variable, and this makes it easier to recognize the contribution of each explanatory variable to prediction. As a result, it is possible to improve explainability (interpretability) of the explanatory variable for the prediction.

At least one or more of the functions of the prediction unit 121, the calculation unit 122, and the output unit 123 described above may be executed by an information processing apparatus installed and connected at any place on a network, that is, may be executed by so-called cloud computing.

The above-described programs can be stored using various types of non-transitory computer readable media and supplied to a computer. The non-transitory computer readable media include various types of tangible storage media. Examples of the non-transitory computer readable medium include a magnetic recording medium (for example, flexible disk, magnetic tape, or hard disk drive), an optical magnetic recording medium (for example, magneto-optical disc), a CD-read only memory (ROM), a CD-R, a CD-R/W, and a semiconductor memory (for example, mask ROM, programmable ROM (PROM), erasable PROM (EPROM), a flash ROM, or a random access memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber, or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

### Supplementary Notes

Some or all of the above example embodiments may also be described as in the following Supplementary Notes. Hereinafter, an outline of configurations of the information processing apparatus, the information processing method, and the program in the present disclosure will be described. However, the present disclosure is not limited to the configurations described in the following Supplementary Notes.

Some or all of the configurations described in Supplementary Notes 2 to 8.1 dependent on Supplementary Note 1 described below and the functions according to those configurations can also be dependent on other Supplementary Notes 9 and 10 by a dependency relationship similar to that of Supplementary Notes 2 to 8.1. Moreover, some or all of the configurations described as the supplementary notes and the functions according to those configurations can be similarly dependent on not only Supplementary Notes 1, 9, and 10, but also various pieces of similar hardware and software, and various types of recording means that record the software, or systems without departing from the above-described example embodiments.

### Supplementary Note 1

An information processing apparatus including:
a prediction unit that predicts an objective variable representing a state of a prediction target by inputting, to a prediction model, vector data obtained by vectorizing explanatory variables, each of the explanatory variables being data related to the prediction target;
a calculation unit that calculates, as an explainability index, a contribution of each element of the vector data to the objective variable; and
an output unit that edits, for each of the explanatory variables, the explainability index for each element of the vector data corresponding to the explanatory variable to a predetermined number, and outputs information based on an editing result.

### Supplementary Note 2

The information processing apparatus according to Supplementary Note 1, in which
in the vector data, the explanatory variables are individually vectorized into elements of a predetermined number of dimensions, and
the output unit edits, for each of the explanatory variables, the explainability index in such a way as to be dimensionally reduced as compared with the number of dimensions of the vector data, and outputs information based on an editing result.

### Supplementary Note 3

The information processing apparatus according to Supplementary Note 2, in which
the output unit obtains a one-dimensional value, which is a sum of the explainability indices, for each of the explanatory variables, and outputs information based on the one-dimensional value.

### Supplementary Note 4

The information processing apparatus according to Supplementary Note 3, in which
the output unit outputs information in which a distinction is made between positive and negative values obtained by making the explainability indices one-dimensional for each of the explanatory variables.

### Supplementary Note 4.1

The information processing apparatus according to Supplementary Note 3, in which
the output unit outputs a graph based on magnitude of values obtained by making the explainability indices one-dimensional for each of the explanatory variables.

### Supplementary Note 5

The information processing apparatus according to Supplementary Note2, in which
the output unit obtains two-dimensional values, which are a sum of positive values and a sum of negative values of the explainability indices for each of the explanatory variables, and outputs information based on each of the two-dimensional values.

### Supplementary Note 5.1

The information processing apparatus according to Supplementary Note 5, in which
the output unit outputs a graph based on magnitude of each of values obtained by making the explainability indices two-dimensional for each of the explanatory variables.

### Supplementary Note 6

The information processing apparatus according to Supplementary Note 2, in which
the output unit outputs, for each of the explanatory variables, information based on a value of the dimensionally reduced explainability index, together with information based on a distribution of the explainability index corresponding to the explanatory variable.

### Supplementary Note 6.1

The information processing apparatus according to Supplementary Note 6, in which
the output unit outputs, for each of the explanatory variables, a first graph based on the distribution of the explainability index corresponding to the explanatory variable, and also outputs a second graph based on the value of the dimensionally reduced explainability index.

### Supplementary Note 7

The information processing apparatus according to Supplementary Note 1, in which
the output unit generates and outputs information regarding a measure for the prediction target based on the editing result of the explainability index for each of the explanatory variables.

### Supplementary Note 8

The information processing apparatus according to Supplementary Note 1, in which
the output unit controls a predetermined device based on the editing result of the explainability index for each of the explanatory variables.

### Supplementary Note 8.1

The information processing apparatus according to Supplementary Note 1, including
an acquisition unit that acquires, based on a state of connection between the prediction targets and a plurality of the explanatory variables in different data formats of the prediction targets, the vector data of each of the explanatory variables related to the prediction targets.

### Supplementary Note 9

An information processing method including,
by an information processing apparatus:
predicting an objective variable representing a state of a prediction target by inputting, to a prediction model, vector data obtained by vectorizing explanatory variables, each of the explanatory variables being data related to the prediction target;
calculating, as an explainability index, a contribution of each element of the vector data to the objective variable; and
editing, for each of the explanatory variables, the explainability index for each element of the vector data corresponding to the explanatory variable to a predetermined number, and outputting information based on an editing result.

### Supplementary Note 10

A program for causing
an information processing apparatus to execute processing including:
predicting an objective variable representing a state of a prediction target by inputting, to a prediction model, vector data obtained by vectorizing explanatory variables, each of the explanatory variables being data related to the prediction target;
calculating, as an explainability index, a contribution of each element of the vector data to the objective variable; and
editing, for each of the explanatory variables, the explainability index for each element of the vector data corresponding to the explanatory variable to a predetermined number, and outputting information based on an editing result.

1. An information processing apparatus comprising:
at least one memory configured to store processing instructions; and
at least one processor configured to execute the processing instructions to:
predict an objective variable representing a state of a prediction target by inputting, to a prediction model, vector data obtained by vectorizing explanatory variables, each of the explanatory variables being data related to the prediction target;
calculate, as an explainability index, a contribution of each element of the vector data to the objective variable; and
edit, for each of the explanatory variables, the explainability index for each element of the vector data corresponding to the explanatory variable to a predetermined number, and output information based on an editing result.

2. The information processing apparatus according to claim 1, wherein
in the vector data, the explanatory variables are individually vectorized into elements of a predetermined number of dimensions, and
the at least one processor is configured to execute the processing instructions to edit, for each of the explanatory variables, the explainability index in such a way as to be dimensionally reduced as compared with the number of dimensions of the vector data, and output information based on an editing result.

3. The information processing apparatus according to claim 2, wherein the at least one processor is configured to execute the processing instructions to
obtain a one-dimensional value, which is a sum of the explainability indices, for each of the explanatory variables, and output information based on the one-dimensional value.

4. The information processing apparatus according to claim 3, wherein the at least one processor is configured to execute the processing instructions to
output information in which a distinction is made between positive and negative values obtained by making the explainability indices one-dimensional for each of the explanatory variables.

5. The information processing apparatus according to claim 3, wherein the at least one processor is configured to execute the processing instructions to
output a graph based on magnitude of values obtained by making the explainability indices one-dimensional for each of the explanatory variables.

6. The information processing apparatus according to claim 2, wherein the at least one processor is configured to execute the processing instructions to
obtain two-dimensional values, which are a sum of positive values and a sum of negative values of the explainability indices for each of the explanatory variables, and output information based on each of the two-dimensional values.

7. The information processing apparatus according to claim 6, wherein the at least one processor is configured to execute the processing instructions to
output a graph based on magnitude of each of the values obtained by making the explainability indices two-dimensional for each of the explanatory variables.

8. The information processing apparatus according to claim 2, wherein the at least one processor is configured to execute the processing instructions to
output, for each of the explanatory variables, information based on a value of the dimensionally reduced explainability index, together with information based on a distribution of the explainability index corresponding to the explanatory variable.

9. The information processing apparatus according to claim 8, wherein the at least one processor is configured to execute the processing instructions to
output, for each of the explanatory variables, a first graph based on the distribution of the explainability index corresponding to the explanatory variable, and also output a second graph based on the value of the dimensionally reduced explainability index.

10. The information processing apparatus according to claim 1, wherein the at least one processor is configured to execute the processing instructions to
generate and output information regarding a measure for the prediction target based on the editing result of the explainability index for each of the explanatory variables.

11. The information processing apparatus according to claim 1, wherein the at least one processor is configured to execute the processing instructions to
control a predetermined device based on the editing result of the explainability index for each of the explanatory variables.

12. The information processing apparatus according to claim 1, wherein the at least one processor is configured to execute the processing instructions to
acquire, based on a state of connection between the prediction targets and a plurality of the explanatory variables in different data formats of the prediction targets, the vector data of each of the explanatory variables related to the prediction targets.

13. An information processing method comprising,
by an information processing apparatus:
predicting an objective variable representing a state of a prediction target by inputting, to a prediction model, vector data obtained by vectorizing explanatory variables, each of the explanatory variables being data related to the prediction target;
calculating, as an explainability index, a contribution of each element of the vector data to the objective variable; and
editing, for each of the explanatory variables, the explainability index for each element of the vector data corresponding to the explanatory variable to a predetermined number, and outputting information based on an editing result.

14. A non-transitory computer-readable storage medium storing a program for causing
an information processing apparatus to execute processing comprising:
predicting an objective variable representing a state of a prediction target by inputting, to a prediction model, vector data obtained by vectorizing explanatory variables, each of the explanatory variables being data related to the prediction target;
calculating, as an explainability index, a contribution of each element of the vector data to the objective variable; and
editing, for each of the explanatory variables, the explainability index for each element of the vector data corresponding to the explanatory variable to a predetermined number, and outputting information based on an editing result.
